(19) United States
(12) Patent Application Publication
(10) Pub. No.: US 2011/0195762 A1
(43) Pub. Date: Aug. 11, 2011

(54) TERMINAL INCLUDING ROTATABLE BODY

(75) Inventors: Byoung Soo NOH, Daejeon (KR); June JANG, Seoul (KR)

(73) Assignee: PANTECH CO., LTD., Seoul (KR)

(21) Appl. No.: 13/024,603

(22) Filed: Feb. 10, 2011

(30) Foreign Application Priority Data
Feb. 11, 2010 (KR) 10-2010-0012782

(51) Int. Cl. H04W 88/02

(52) U.S. Cl. 455/575.4

(57) ABSTRACT

A terminal with improved usability may include a body unit including a first body, a second body disposed adjacent to the first body, a third body disposed to face the first body and the second body; a movement unit to semi-automatically slide the third body between a first position in which the third body covers a front surface of the first body and a front surface of the second body, and a second position in which the third body is slid to expose a front surface of the second body; and a tilting unit to rotate the second body towards the third body.

### CROSS-REFERENCE TO RELATED APPLICATION

This application claims priority from and the benefit under 35 U.S.C. §119(a) of Korean Patent Application No. 10-2010-0012782, filed on Feb. 11, 2010, which is hereby incorporated by reference for all purposes as if fully set forth herein.

### BACKGROUND

1. Field

Exemplary embodiments of the present invention relate to a terminal that may expose a front surface of a body on which manipulation keys are provided.

2. Discussion of the Background

As an example of general terminals by which a user transmits/receives signals with another party, mobile communication terminals enable the user to communicate with the other party even when the user is moving. Mobile communication terminals may include a cellular phone, a personal communication service (PCS) phone, a personal digital assistant (PDA), and the like. The general terminals may be classified into a bar-type, a flip type, a folder type, a slide type, and the like, and may be selected based on convenience and portability desired by the user. These various types of mobile communication terminals may be classified based on a display panel on which information is displayed and input keys through which information is inputted.

Here, the slide type terminal may generally include an upper body having the display panel formed thereon to be always exposed to the outside and a lower body in which a region of the lower body is selectively exposed by a sliding movement of the upper body. In this instance, if the upper body of the slide type terminal slides relative to the lower body of the slide type terminal by a distance, the input keys mounted in the lower body may be generally exposed.

In addition, in the general slide type terminal, a guide that enables a sliding operation of the upper body may be mounted between the upper body and the lower body, and thereby only a portion of the lower body may be exposed upon sliding of the upper body relative to the lower body, causing a limitation in use of the lower body and the input keys.

Also, in a case of the slide type terminal, a sliding direction of the terminal is created in such a manner that the upper body slides parallel to the lower body. Specifically, the upper body and the lower body slide along a plane while keeping a distance spaced between the upper body and the lower body. Accordingly, an inconvenience may occur where the user should manipulate the upper body to align information displayed through the slid upper body with a viewing angle of the user, or in that the user should slouch to face the terminal.

Also, in a case multimedia services, such as moving pictures and the like, are provided using the terminal, it may be cumbersome and inconvenient for a user to use a separate holding stand for the terminal to adjust the viewing angle of the user in order to view the multimedia services for an extended period of time.

### SUMMARY

Exemplary embodiments of the present invention provide a terminal that may increase a usable area of the terminal.

Exemplary embodiments of the present invention provide a terminal that may perform a sliding operation and a rotation operation, thereby improving usability and operability of the terminal.

Exemplary embodiments of the present invention provide a terminal in which a third body may be deviated from a second body if to a second position so that a front surface of the second body is exposed, thereby increasing a usable area of the second body.

Exemplary embodiments of the present invention provide a terminal in which a third body may be slid relative to a first body and a second body, and the second body may rotate towards the third body and be exposed, thereby improving usability and operability of the terminal.

Exemplary embodiments of the present invention provide a terminal in which a second body is rotated towards a third body, thereby increasing a viewing angle of a user.

Additional features of the invention will be set forth in the description which follows, and in part will be apparent from the description, or may be learned by practice of the invention.

An exemplary embodiment provides a terminal including a body unit including a first body, a second body disposed adjacent to the first body, and a third body disposed to face the first body and the second body; a movement unit to guide a movement of the third body between a first position in which the third body covers the first body and the second body, and a second position in which the second body is exposed; and a tilting unit to rotate the second body to complete the movement of the third body to the second position.

An exemplary embodiment provides a terminal, including: a body unit including a first body, a second body disposed adjacent to the first body, and a third body disposed to face the first body and the second body; a movement unit to semi-automatically slide the third body between a first position in which the third body covers a front surface of the first body and a front surface of the second body, and a second position in which the third body slides along the front surface of the second body to expose the second body, the second position being different from the first position; and a tilting unit to rotate the second body towards the third body based on removal of a restraining power of the second body by the third body due to a movement of the third body relative to the second body.

An exemplary embodiment provides terminal, including: a body unit including: a first body, a second body disposed adjacent to the first body, and a third body disposed to face the first body and the second body; a movement unit to guide a movement of the third body between a first position in which the third body covers the first body and the second body, and a second position in which the second body is exposed; and wherein the first body includes a first gear and a second gear, the first gear and the second gear are engaged with each other and rotatable, the first gear is connected to the second body by a connection plate, and a rotation of the second gear is stoppable by a contact of an interception protrusion connected to the second gear with a latching protrusion so as to stop a rotation of the second body in the second position.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view illustrating a terminal according to an exemplary embodiment.

FIG. 2 is a perspective view illustrating the terminal of FIG. 1 in a first position.

FIG. 3 is a perspective view illustrating the terminal of FIG. 1 in a second position different from the first position of FIG. 2.

FIG. 4 is a schematic side cross-sectional view illustrating the terminal of FIG. 1 positioned in the first position of FIG. 2.

FIG. 5 is a top view of the terminal of FIG. 4.

FIG. 6 is a schematic side cross-sectional view illustrating the terminal of FIG. 1 moved from a first position of FIG. 2 toward the second position of FIG. 3.

FIG. 7 is a top view of the terminal of FIG. 6.

FIG. 8 is a schematic side cross-sectional view illustrating a state where an interception jaw intercepts a tilting protrusion while the terminal of FIG. 1 approaches the second position of FIG. 3.

FIG. 9 is a top view of the terminal of FIG. 8.

FIGS. 10 and 11 are schematic side cross-sectional views illustrating a second body of the terminal of FIG. 1 being rotated.

FIG. 12 is a schematic side cross-sectional view illustrating the terminal of FIG. 1 positioned in the second position of FIG. 3.

FIG. 13 is a cross-sectional view of a stopper according to an exemplary embodiment.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element, such as a layer, film, region, substrate, or plate is referred to as being “formed on”, “disposed on”, or “connected to” another element, it can be formed directly on, disposed directly on, or connected directly to the other element, or intervening elements may also be present. In contrast, when an element is referred to as being “formed directly on”, “disposed directly on”, or “connected directly to” another element, there are no intervening elements present.

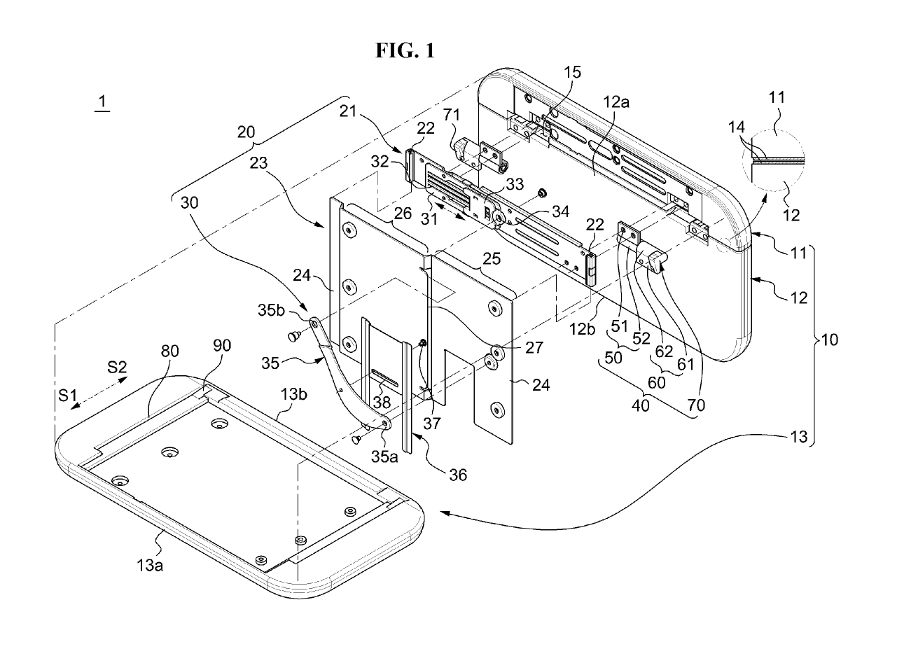

FIG. 1 is an exploded perspective view illustrating a terminal 1 according to an exemplary embodiment. Referring to FIG. 1, the terminal 1 includes a body unit 10, a movement unit 20, and a tilting unit 40.

The terminal 1 according to an exemplary embodiment may be a handheld terminal mobile communication, such as a cellular phone, a personal digital assistant (PDA) phone, a digital multimedia broadcasting (DMB) phone, and the like. However, aspects of the present invention are not limited thereto, and the terminal 1 may be an electronic equipment that includes an input unit and a display unit, such as an electronic dictionary, etc.

The body unit 10 includes a first body 11, a second body 12 disposed adjacent to the first body 11, and a third body 13 disposed to face each of the first body 11 and the second body 12. The first body 11 and the second body 12 may have front surfaces that generally share a plane and rear surfaces that generally share a plane. The first body 11 may have the same width as a width of the second body 12, and may be formed into a rectangular-like shape having a length smaller than that of the second body 12. The second body 12 may be formed into a rectangular-like shape, and may be disposed to be adjacent to the first body 11. Thus, a volume of the first body 11 may be relatively smaller than a volume of the second body 12.

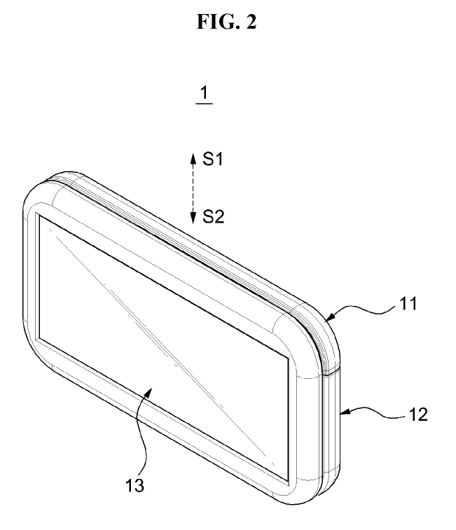

A height of the first and second bodies 11 and 12 may be the same, resulting in obtaining a smooth outer appearance. The third body 13 may have a length corresponding to a sum of the lengths of the first body 11 and the second body 12, and a width corresponding to the widths of the first body 11 and the second body 12. Accordingly, as illustrated in FIG. 2, a first side portion 13a and a second side portion 13b of the third body 13 may align with sides of the first body 11 and the second body 12, respectively, so that the third body may completely cover front surfaces of each of the first body 11 and the second body 12.

A buffer member 14 may be disposed on at least one of the first body 11 and the second body 12 disposed between the first body 11 and the second body 12, so that a shock generated due to a close contact between the first body 11 and the second body 12 may be relieved. Although not illustrated, an input key portion may be provided on the front surface of the second body 12, and a display panel may be provided on a front surface of the third body 13. Here, the display panel may be configured such that manipulation data is inputted by a touch input scheme.

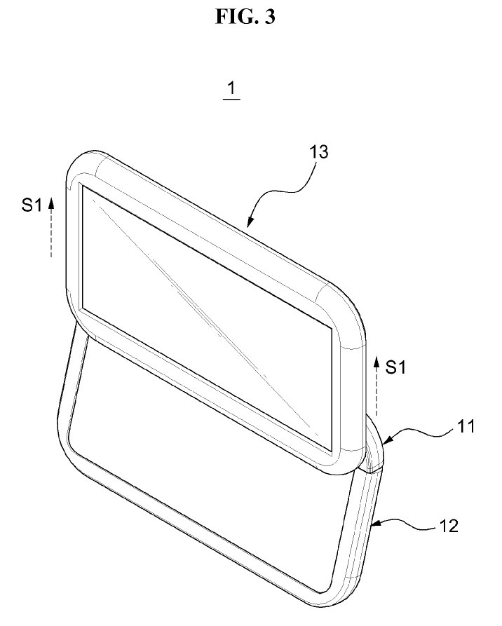

FIG. 2 is a perspective view illustrating the terminal of FIG. 1 in a first position, and FIG. 3 is a perspective view illustrating the terminal of FIG. 1 in a second position different from the first position of FIG. 2. The movement unit 20 may support, as illustrated in FIGS. 2 and 3, a sliding movement of the third body 13 sliding along the front surface of the first and second bodies 11 and 12. More specifically, the movement unit 20 may support the sliding movement of the third body 13 between a first position in which the first side portion 13a and the second side portion 13b of the third body 13 respectively align with the sides of the first body 11 and the second body 12 and a second position in which the second side portion 13b of the third body 13 faces the first body 11. The third body 13 may be slidably moved from the first position to the second position so that the second position is different from the first position. In this instance, the third body 13 may be disposed away from the first body 11 in the second position so that the front surface of the second body 12 may be almost completely or completely exposed. For this, as illustrated in FIG. 1, the movement unit 20 includes a first plate 21, a second plate 23, and an operation portion 30. The movement unit 20 may enable the third body 13 to slide between the first position and the second position.

The first plate 21 may be disposed between the first body 11 and the third body 12, and fixedly mounted on the first body 11. Here, the first plate 21 may include a first rail 22 formed parallel to movement directions S1 and S2 in which the third body 13 slides between the first position and the second position. A pair of first rails 22 may be provided such that a first rail 22 is disposed at each end of the first plate 21. One or each end of the first plate 22 may be bent to form the first rails 22 in the movement directions S1 and S2.

The second plate 23 may be connected to the third body 13 and may slide along the first rail 22. The second plate 23 may have a length similar to that of the third body 13, and ends 24 of the second plate 23 may be inserted into the pair of first rails 22 of the first plate 21 in the movement directions 51 and S2, so that the third body 13 may be slidably supported by the second plate 23. Specifically, the second plate 23 may slide in the movement directions 51 and S2 in a state of supporting the third body 13 relative to the first plate 21, which is fixedly mounted on the first body 11.

The second plate 23 may include a first portion 25 protrusively formed towards the first body 11 and the second body 12 and a second portion 26 protrusively formed towards the third body 13, so that the first portion 25 and the second portion 26 may be stepped. The first portion 25 and the second portion 26 may be distinguished in a width direction of the second plate 23, i.e., the first portion 25 and a second portion 26 are distinguished along a line of the second plate 23 parallel to the sliding direction. Specifically, the second plate 23 may include the first portion 25 and the second portion 26 formed to have a step height therebetween, relative to the first and second bodies 11 and 12 or relative to the third body 13. Here, the both side ends 24 of the second plate 23 extendedly formed from the first portion 25 and the second portion 26 may be positioned at a same height, and more specifically, may have the same height as that of the first portion 25. Here, a slot 27 may be formed between the first portion 25 and the second portion 26.

The first plate 21 and the second plate 23 may be component elements of the movement unit 20 that enables the third body 13 to be slidably moved relative to the first body 11; however aspects of the present invention are not limited thereto. Specifically, various examples may be provided such that a rail and a rail protrusion inserted into the rail may be respectively formed on the first body 11 and the third body 13 without separately including the first plate 21 and/or the second plate 23 so that the third body 13 may be slidably moved relative to the first body 11.

The operation unit 30 may generate a semi-automatic sliding force of the second plate 23 relative to the first plate 21. Specifically, the operation unit 30 may provide the semi-automatic sliding force to the second plate 23 connected to the third body 13 so that the third body 13 may semi-automatically slide. The operation unit 30 may include a third plate 31, a fourth plate 33, and a fifth plate 35.

The third plate 31 may include a second rail 32 formed parallel to a width direction of the first body 11, the second body 12, and the third body 13, i.e., a direction perpendicular to the movement directions 51 and S2. The third plate 31 including the second rail 32 may be mounted on the first plate 21 to face the second plate 23.

The fourth plate 33 may be mounted on the third plate 31 to slide along the second rail 32. In this instance, the fourth plate 33 may be disposed between the second plate 23 and the third plate 31.

A first end 35a and a second end 35b of the fifth plate 35 may be respectively connected to the second plate 23 and the fourth plate 33, so that the second end 35b may be moved along the second rail 32 by the sliding force of the second plate 23. In this instance, the first end 35a of the fifth plate 35 may be fixed on the second plate 23 to be moved together with the third body 13 in the movement directions 51 and S2, and the second end 35b of the fifth plate 35 may be moved together with the fourth plate 33, along the second rail 32. The second end 35b of the fifth plate 35 may be connected to the fourth plate 33 via a pin, or the like, extending through a through-hole 34, but aspects are not limited thereto. The first end 35a and the second end 35b of the fifth plate 35 may each be rotatably fixed such that the first end 35a rotates about the connection to the second plate 23 and the second end 35b rotates about the connection to the fourth plate 33 as the first end 35a moves with the second plate 23 and the second end 35b moves with the fourth plate 33. The fifth plate 35 may be formed into a streamlined shape, and extendedly formed to the second side portion 13b of the third body 13, so that the fifth plate 35 may be moved along the second rail 32 by a movement of the second plate 23 to generate a semi-automatic sliding force, such as a force provided in a leaf spring. Specifically, the fifth plate 35 may be bent between the first end 35a and the second end 35b, and may be bent to a greater degree between a central portion and the first end 35a of the fifth plate 35 than between the central portion and the second end 35b of the fifth plate 35.

Also, the fifth plate 35 may be inserted into the slot 27 formed between the first portion 25 and the second portion 26 of the second plate 23. Specifically, the first end 35a of the fifth plate 35 may be disposed between the first portion 25 of the second plate 23 and the third body 13, and the second end 35b of the fifth plate 35 may extend through the slot 27, and be disposed between the second portion 26 of the second plate 23 and the fourth plate 33.

In addition, the operation unit 30 may further include a sixth plate 36 to guide a movement range of the fifth plate 35 moved along the second rail 32. The sixth plate 36 may include a third rail 38 formed parallel to the second rail 32 through which a connection body 37 is inserted to connect to the fifth plate 35 such that the connection body 37 slides along the third rail 38. The sixth plate 36 may be disposed between the first end 35a of the fifth plate 35 and the first portion 25 of the second plate 23. Here, the fifth plate 35 may be eccentrically connected to the sixth plate 36 towards the first end 35a.

The tilting unit 40 may rotate the second body 12 towards the third body 13 relative to the first body 11 based on a sliding movement of the third body 13 moved to the second position as illustrated in FIG. 3. Specifically, the tilting unit 40 may guide a second side portion 12b of the second body 12, opposite from a first side portion 12a of the second body 12, to be rotated about connection between the first side portion 12a of the second body 12 to the first body 11 so that the second body 12 is inclined with respect to the first body 11 and the third body 13 in the second position. The tilting unit 40 may include a first tilting body 50, a second tilting body 60, a tilting protrusion 70, a tilting rail 80, and an interception jaw 90.

The first tilting body 50 may include a first coupling portion 51 coupled to the first body 11 and a first shaft portion 52 which is a rotation shaft between the first body 11 and the second body 12. Also, the second tilting body 60 may include a second coupling portion 61 coupled to the second body 12 and a second shaft portion 62 on the same shaft as the first shaft portion 52. The first tilting body 50 and the second tilting body 60 may be integrally formed such that the first shaft portion 52 and the second shaft portion 62 are disposed adjacent to each other and may be one shaft. The first tilting body 50 and the second tilting body 60 may be mounted on a groove 15 formed between the first body 11 and the second body 12, i.e., each of the first body 11 and the second body 12 may have a portion of the groove 15 disposed therein. Here, the groove 15 may be formed having a shape corresponding or complementary to the first tilting body 50 and the second tilting body 60.

As shown in FIG. 1, a pair of the first and second tilting bodies 50 and 60 may be disposed in a pair of grooves 15 separated from each other so that connection stability between the first body 11 and the second body 12 may be improved. However, aspects of the present invention are not limited thereto, and thus a single or three or more of the first and second tilting bodies 50 and 60 may be provided. In addition, according to aspects of the present invention, the first tilting body 50 and the second tilting body 60 are respectively connected to the first body 11 and the second body 12; however, the first body 11 and the second body 12 may be connected to each other to be mutually rotated by a single tilting body.

In addition, although not illustrated, an elastic body to provide an elastic force in a direction where the second body 12 is rotated or unrotated relative to the first body 11 may be mounted on the first shaft portion 52 and the second shaft portion 62. The elastic body may be one of a torsion spring, a compression coil spring, and the like.

The tilting protrusion 70 may be protrusively formed from the second tilting body 60 to extend toward the third body 13. According to an exemplary embodiment, a pair of tilting protrusions 70 may be provided on a pair of second tilting bodies 60.

The tilting rail 80 may be recessedly formed on a rear surface of the third body 13 facing the first body 11 and the second body 12 so that the tilting protrusion 70 is inserted into the tilting rail 80. In this instance, the tilting rail 80 may be formed parallel to the movement directions S1 and S2. A pair of tilting rails 80 may be provided on the rear surface of the third body 13 to correspond to the pair of tilting protrusions 70.

The interception jaw 90 may be protrusively formed from the tilting rail 80 and formed on or near the second side portion 13b of the third body 13, so that the second side portion 13b intercepts the tilting protrusion 70 while approaching the second position. The interception jaw 90 may have a rounded or inclined shape extended from the tilting rail 80 toward the second side portion 13b of the third body 13, so that the interception jaw 90 may contact the tilting protrusion 70 to rotate the second body 12 with respect to the first body 11 and the third body 13.

In addition, the tilting protrusion 70 may include an interception surface 71 inclinedly formed in a direction from the second body 12 toward the third body 13 so that a rotation range through which the second body 12 is inclinedly rotated towards the third body 13 may be restricted by an inclined angle of the interception surface 71.

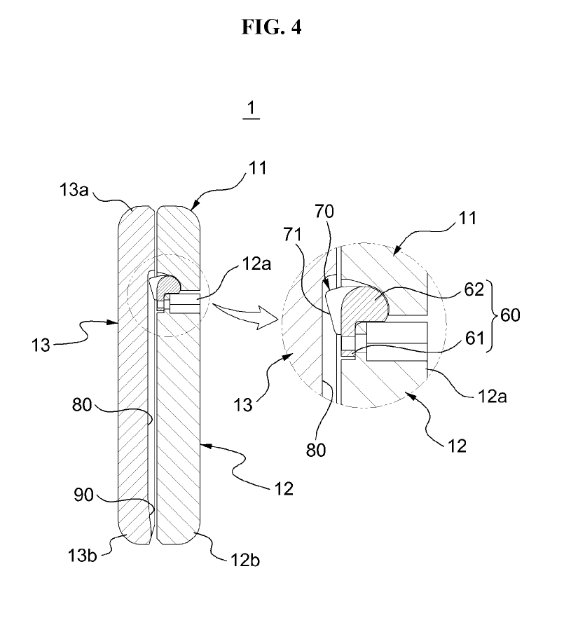

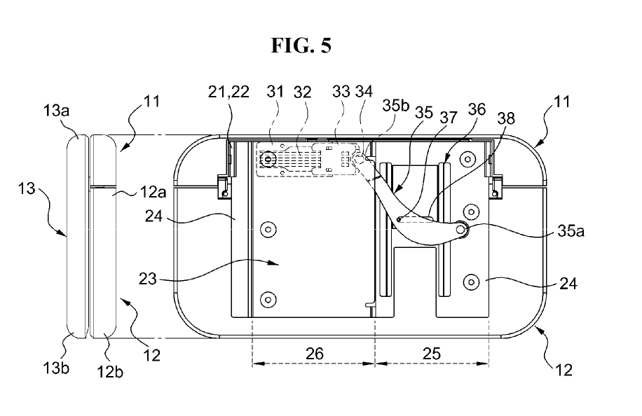

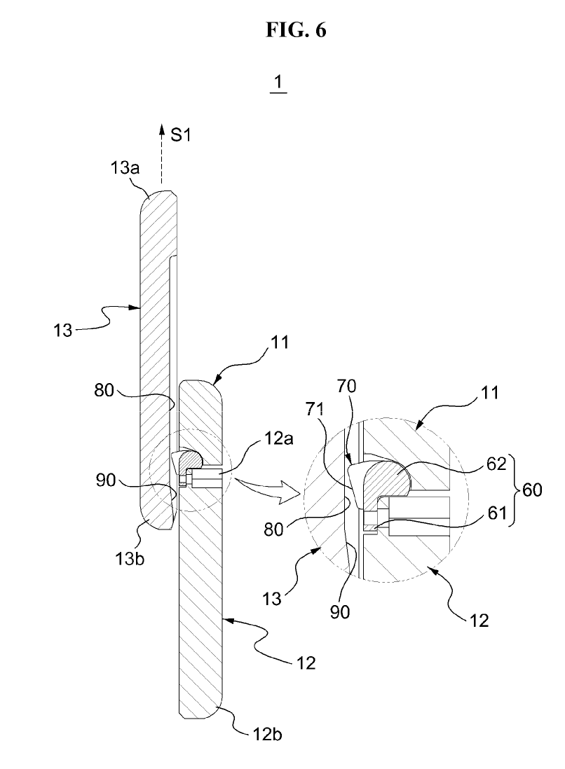

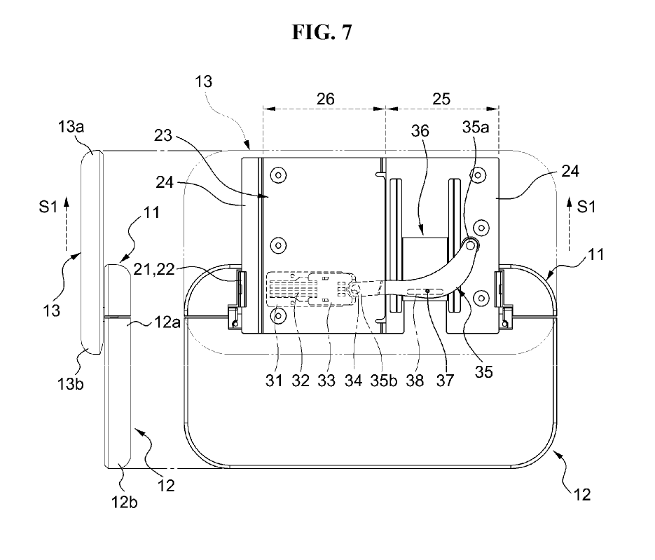

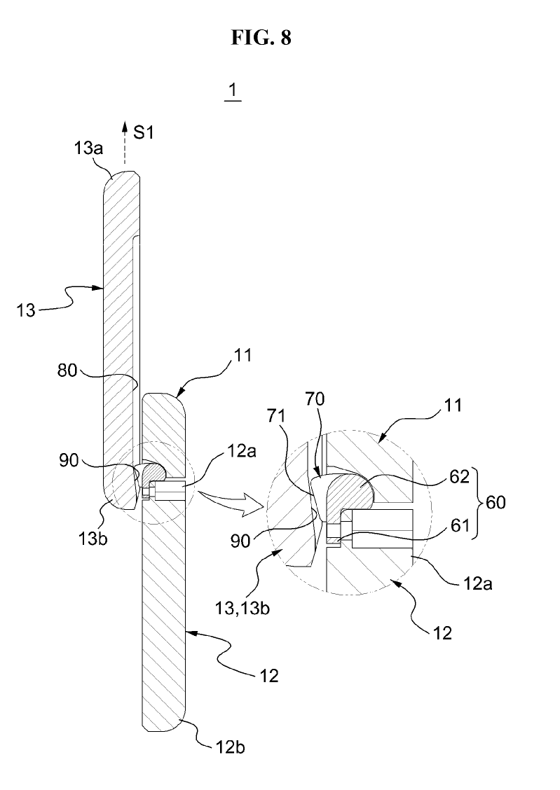

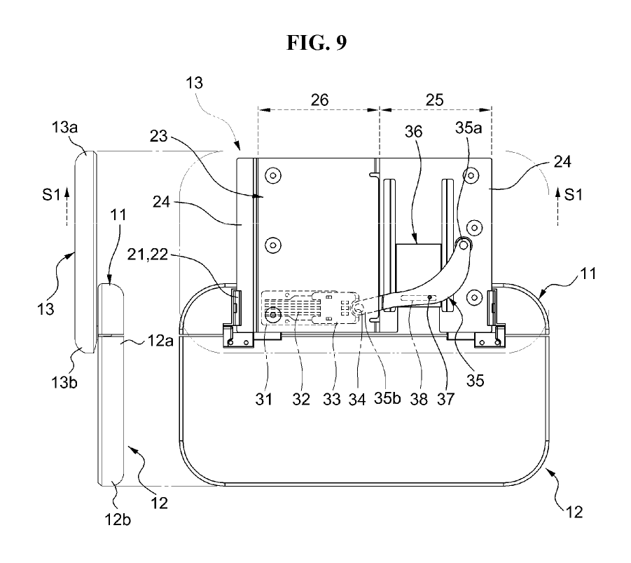

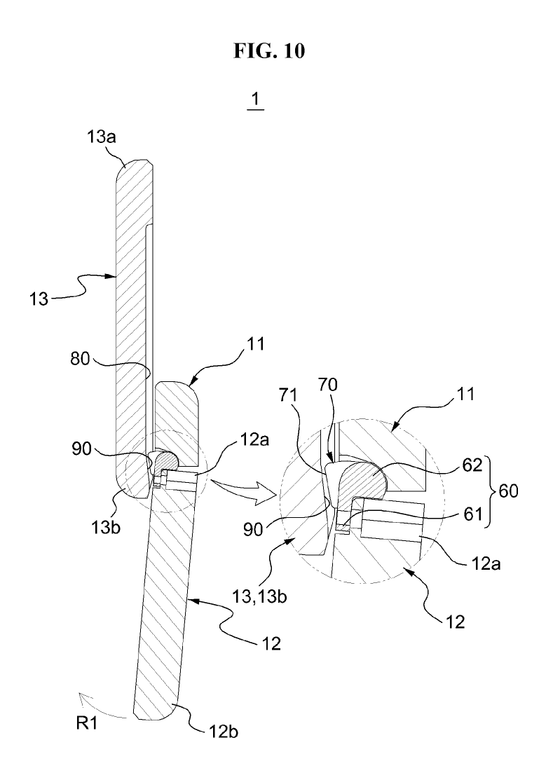

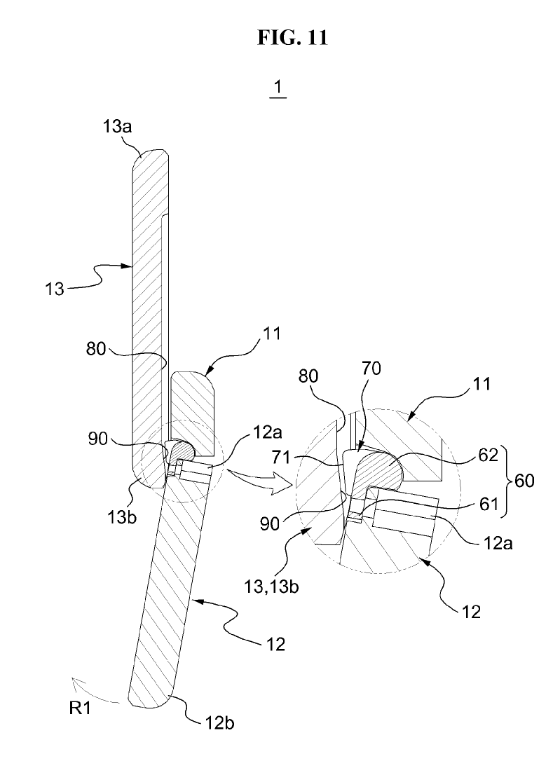

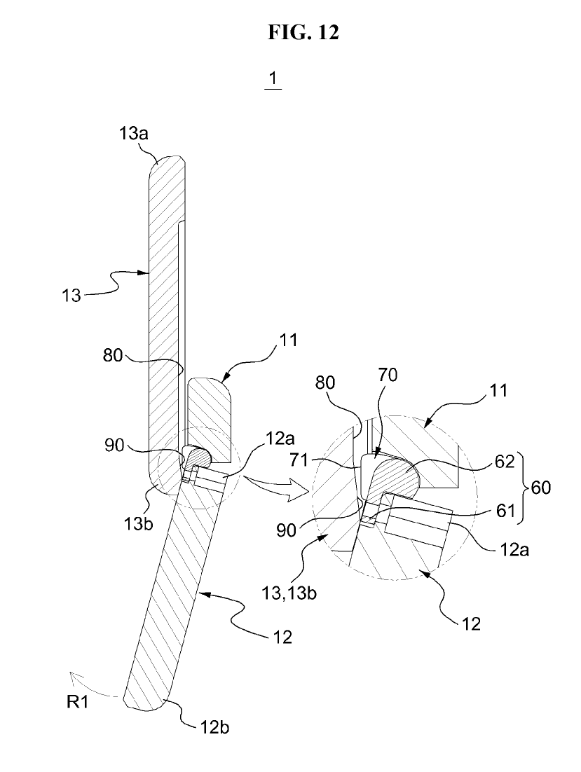

Hereinafter, a sliding operation of the terminal 1 will be described in detail with reference to FIGS. 4 to 12. FIG. 4 is a schematic side cross-sectional view illustrating the terminal of FIG. 1 positioned in the first position of FIG. 2. FIG. 5 is a top view of the terminal of FIG. 4. FIG. 6 is a schematic side cross-sectional view illustrating the terminal of FIG. 1 moved from a first position of FIG. 2 toward the second position of FIG. 3. FIG. 7 is a top view of the terminal of FIG. 6. FIG. 8 is a schematic side cross-sectional view illustrating a state where an interception jaw intercepts a tilting protrusion while the terminal of FIG. 1 approaches the second position of FIG. 3. FIG. 9 is a top view of the terminal of FIG. 8. FIGS. 10 and 11 are schematic side cross-sectional views illustrating a second body of the terminal of FIG. 1 being rotated. FIG. 12 is a schematic side cross-sectional view illustrating the terminal of FIG. 1 positioned in the second position of FIG. 3.

Referring to FIG. 4, if the first side portion 13a and the second side portion 13b of the third body 13 are positioned in the first position in which the first side portion 13a and the second side portion 13b respectively face the first body 11 and the second body 12, i.e., the second side portion 13b of the third body 13 and the second side portion 12b of the second body 12 generally align, the tilting protrusion 70 protrusively formed from the second tilting body 60 is inserted in the tilting rail 80 of the third body 13. As illustrated in FIG. 5, the second end 35b of the fifth plate 35 of the movement unit 20 is connected to the fourth plate 33.

Subsequently, as illustrated in FIG. 6, if the third body 13 is slid in the movement direction 51, the tilting protrusion 70 may be maintained to be inserted in the tilting rail 80 until before the second side portion 13b of the third body 13 is deviated from the second body 12. In this instance, as illustrated in FIG. 7, the second plate 23 connected to the third body 13 may slide along the first rail 22 of the first plate 21, together with the sliding operation of the third body 13 in the movement direction 51. Thus, the first end 35a of the fifth plate 35 connected to the second plate 23 may be moved accordingly in the movement direction S1. Here, together with the movement of the first end 35a of the fifth plate 35 in the movement direction S1, the second end 35b of the fifth plate 35 may be moved along the second rail 32 of the third plate 31 while being connected to the fourth plate 33.

As illustrated in FIG. 8, at the moment the second side portion 13b of the third body 13 is deviated from the second body 12 while the third body 13 continues to move in the movement direction S1, the interception jaw 90, protrusively formed from the tilting rail 80 and formed on the rear surface of the second side portion 13b of the third body 13, and the tilting protrusion 70, protrusively formed from the second tilting body 60, may be engaged. As illustrated in FIG. 9, the first end 35a of the fifth plate 35 may slide in the movement direction S1 together with the second plate 23 mounted on the third body 13. Also, based on the movement of the first end 35a of the fifth plate 35 and the connection between the fifth plate 35 and the third rail 38, the second end 35b of the fifth plate 35 may be moved again as illustrated in FIG. 9, together with the fourth plate 33 moved along the second rail 32. Specifically, the fifth plate 35 may act as a sort of a leaf spring in such a manner that a restoration force, attempting to return to the first position, may be generated due to an operation of the second end 35b of the fifth plate 35, and the restoration force may assist the sliding force of the third body 13 connected to the second plate 23. Specifically, the fifth plate 35 may resist or assist in movement of the third body 13 from the first to the second position according to a point at which the third body 13 has moved relative to the second body 12, i.e., if moving from the first position to the second position, the fifth plate 35 may resist the movement of the third body 13 until a point is passed, after which the fifth plate 35 may assist in the movement of the third body 13 toward the second position; however, aspects are not limited thereto.

As illustrated in FIG. 10, the tilting protrusion 70 may be deviated from the tilting rail 80 and intercepted by the interception jaw 90 formed on the rear surface of the second side portion 13b of the third body 13, while the third body 13 continues to slide in the movement direction S1. In this instance, based on the mutual interception between the interception jaw 90 and the interception surface 71 of the tilting protrusion 70, the second side portion 12b of the second body 12 connected to the second tilting body 60 may be rotated in a direction R1 towards the third body 13 while the second tilting body 60 is rotated. The R1 direction-rotation of the second body 12 may be maintained, as illustrated in FIG. 11, by the S1 direction-sliding force of the third body 13 and the mutual interception between the interception jaw 90 and the tilting protrusion 70. However, aspects are not limited thereto such that the first body 11 and the second body 12 may be under a restraining force or power to be maintained such that front and rear surfaces thereof are generally parallel, and, if the restraining force or power of the second body 12 is removed by the sliding of the third body 13 to or toward the second position, the second body 12 may be rotated by a tilting unit, for example, including an elastic member, such as a torsion or leaf spring, toward the third body 13 with respect to the first body 11 and the third body 13.

The interception of the tilting protrusion 70 by the interception jaw 90 and a rotation of the tilting protrusion 70 while the third body 13 continues to be moved in the movement direction S1 may proceed until being restricted by the second side portion 13b of the third body 13. Consequently, as illustrated in FIG. 12, the R1 direction-rotation of the second side portion 12b of the second body 12 may be completed, and thereby the second side portion 12b may be seated in the second position. As a result, the front surface of the second body 12 may be exposed by the sliding operation of the third body 13.

As described above, the third body 13 of the terminal 1 moves from the first position to the second position; however, the third body 13 positioned in the second position may be positioned in the first position by being subjected to the opposite processes of FIGS. 4 through 12.

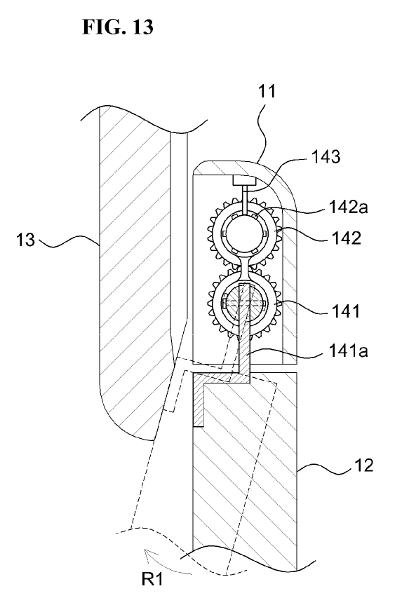

According to an exemplary embodiment, a rotation angle of the second body 12 may be determined by a contact angle between the tilting protrusion 70 and the interception jaw 90; however, aspects of the present invention are not limited thereto. For example, as illustrated in FIG. 13, a separate stopper 140 may be further provided to restrict the rotation angle of the second body 12. Hereinafter, according to an exemplary embodiment, the terminal 100 including the stopper 140 will be further described with reference to FIG. 13. The movement unit 20 and the tilting unit 40 were described in detail with reference to FIGS. 1 to 12, and thus further descriptions thereof will be omitted in FIG. 13.

FIG. 13 is a cross-sectional view of a stopper according to an exemplary embodiment. As illustrated in FIG. 13, the stopper 140 of the terminal 100 includes a first gear 141 and a second gear 142 mounted to both be circumscribed within the first body 11 so that the first gear 141 and the second gear 142 are engaged with each other and rotatable. Here, the first gear 141 may be connected to the second body 12 by a connection plate 141a, and the second gear 142 may include a plurality of interception protrusions 142a separated from each other by a distance in a rotation direction of the second gear 142. In this instance, the plurality of interception protrusions 142a may be latched to a latching protrusion 143 disposed inside the first body 11, so that a rotation of the second gear 142 may be restricted.

In the terminal 100 including the stopper 140, if the third body 13 slides to the second position by the movement unit 20 and the tilting unit 40 as shown in FIGS. 1 to 12, relative to the first body 11 and the second body 12, and the second body 12 is rotated, the first gear 141 connected to the second body 12 by the connection plate 141a may be rotated by the rotation of the second body 12. Subsequently, if the second gear 142 engaged with the first gear 141 is rotated, the plurality of interception protrusions 142a may be selectively latched to the latching protrusion 143, and thereby the rotation of the second gear 142 may be restricted. Here, the first gear 141 engaged with the second gear 142 may be restricted accordingly, and thereby the rotation of the second body 12 connected to the first gear 141 may be restricted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a body unit comprising:
a first body,
a second body disposed adjacent to the first body, and
a third body disposed to face the first body and the second body;
a movement unit to guide a movement of the third body between a first position in which the third body covers the first body and the second body, and a second position in which the second body is exposed; and
a tilting unit to rotate the second body to complete the movement of the third body to the second position.

2. The terminal of claim 1, wherein the movement unit comprises:
an operation portion to semi-automatically operate the third body between the first position and the second position.

3. The terminal of claim 2, wherein the movement unit further comprises:
a first plate disposed on a front surface of the first body, the first plate comprising a rail at each end thereof; and
a second plate disposed on a rear surface of the third body, the second plate comprising ends inserted into the rails.

4. The terminal of claim 3, wherein the movement unit further comprises:
a third plate comprising a first end rotatably connected to the second plate and a second end slidably connected to the second plate.

5. The terminal of claim 4, wherein the second plate comprises a slot through which the third plate extends to connect to the first plate.

6. The terminal of claim 4, wherein the movement unit further comprises:
a fourth plate disposed between the second plate and the third plate, the fourth plate comprising a second rail, wherein a central portion of the third plate is connected to the fourth plate to slide along the second rail.

7. The terminal of claim 1, further comprising a buffer disposed between the first body and the second body.

8. The terminal of claim 1, wherein the tilting unit comprises:
a tilting protrusion to contact the third body to rotate the second body toward the third body.

9. The terminal of claim 8, wherein the tilting unit further comprises:
a tilting body to rotatably connect the first body and the second body;
a tilting rail recessedly formed on a rear surface of the third body, the rear surface facing the first body and the second body, wherein the tilting protrusion is inserted into the tilting rail, the tilting rail being formed parallel to a movement direction of the third body between the first position and the second position; and
an interception jaw protrusively formed from the tilting rail and formed at an end portion of the third body facing the second body, the interception jaw to contact the tilting protrusion while approaching the second position, and
the tilting protrusion comprising an interception surface inclinedly formed in a direction from the second body toward the third body and being protrusively formed from the tilting body towards the third body.

10. The terminal of claim 8, wherein the tilting unit comprises a stopper to restrain a rotation range of the second body relative to the first body.

11. The terminal of claim 1, wherein the first body has a relatively smaller volume than that of the second body, a manipulation key is formed on the second body, and a display panel is formed on the third body.

12. The terminal of claim 1, wherein the first body and the second body are rotatably connected by the tilting unit.

13. The terminal of claim 12, wherein, in the second position, the second body is rotated with respect to the first body and the third body.

14. A terminal, comprising:
a body unit comprising:
a first body,
a second body disposed adjacent to the first body, and
a third body disposed to face the first body and the second body;
a movement unit to semi-automatically slide the third body between a first position in which the third body covers a front surface of the first body and a front surface of the second body, and a second position in which the third body slides along the front surface of the second body to expose the second body, the second position being different from the first position; and
a tilting unit to rotate the second body towards the third body based on removal of a restraining power of the second body by the third body due to a movement of the third body relative to the second body.

15. The terminal of claim 14, wherein the tilting unit comprises:
a tilting body to rotatably connect the first body and the second body;
a tilting protrusion protrusively formed from the tilting body towards the third body;
a tilting rail recessedly formed on a rear surface of the third body, the rear surface facing the first body and the second body, wherein the tilting protrusion is inserted into the tilting rail, the tilting rail being formed parallel to a movement direction of the third body between the first position and the second position; and
an interception jaw protrusively formed from the tilting rail and formed at an end portion of the third body facing the second body, the interception jaw contacting the tilting protrusion while the third body approaches the second position.

16. A terminal, comprising:
a body unit comprising:
a first body,
a second body disposed adjacent to the first body, and
a third body disposed to face the first body and the second body;
a movement unit to guide a movement of the third body between a first position in which the third body covers the first body and the second body, and a second position in which the second body is exposed; and
wherein the first body comprises a first gear and a second gear, the first gear and the second gear are engaged with each other and rotatable, the first gear is connected to the second body by a connection plate, and a rotation of the second gear is stoppable by a contact of an interception protrusion connected to the second gear with a latching protrusion so as to stop a rotation of the second body in the second position.
